(19) United States
(12) Patent Application Publication
(10) Pub. No.: US 2018/0295032 A1
(43) Pub. Date: Oct. 11, 2018

(54) Support of Flexible Radio Protocol in 5G Radio Access Network

(71) Applicant: Nokia Technologies Oy, Espoo (FI)

(72) Inventors: Ling Yu, Espoo (FI); Vinh Van Phan, Oulu (FI); Kari Horneman, Oulu (FI)

(21) Appl. No.: 15/574,987

(22) PCT Filed: May 29, 2015
(86) PCT No.: PCT/US2015/033328

§ 371 Date: Nov. 17, 2017

(51) Int. Cl. H04L 12/24; H04W 24/02

(52) U.S. Cl. CPC H04L 41/5054; H04W 24/02; H04L 41/5058

(57) ABSTRACT

Systems, methods, apparatuses, and computer program products for support of flexible radio protocol in service networks, such as 5G radio access networks are provided. One method may include deciding, by a network entity, to customize or enhance service capability of a service network, wherein the service network comprises a plurality of network access elements, and configuring certain network functions or services flexibly among the network elements of the service network.

### BACKGROUND

### Field

Embodiments of the invention generally relate to wireless communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), future 5G radio access technology, and/or High Speed Packet Access (HSPA).

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and most of the RNC functionalities are contained in the enhanced Node B (eNodeB or eNB).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplex (FDD) and Time Division Duplex (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility. One the key features of LTE-A, introduced in LTE Rel-10, is carrier aggregation (CA), which allows for increasing the data rates through aggregation of two or more LTE carriers.

5^{th} generation wireless systems (5G) refers to the general future evolution or revolution of mobile telecommunications standards beyond the current 4G/IMT-A standards.

### SUMMARY

One embodiment is directed to a method, which may include deciding, by a network entity, to customize or enhance service capability of a service network. The service network may comprise a plurality of network access elements. The method may also include configuring at least one certain network function or service flexibly among the network access elements of the service network.

In one embodiment, the at least one certain network function may be a function of a radio protocol stack. In some embodiments, the configuring may comprise adding or removing on-the-fly a piece of add-on software corresponding to the at least one certain network function or service of the radio protocol stack.

According to an embodiment, the method may further include receiving a network functions or services support capability indication from at least one of the network access elements. In some embodiments, the network functions or services support capability indication may be received before deciding to customize or enhance the service capability.

In an embodiment, the method may also include, when one of the network access elements of the service network performs network functions or services self-reconfiguration, receiving a cell level network functions or services reconfiguration indication from said one of the network access elements. According to some embodiments, the method may further include indicating or receiving user equipment level network functions or services configuration or reconfiguration during user equipment connection establishment or reconfiguration.

According to an embodiment, the method may also include indicating or receiving service flow or service sub-flow level network functions or services configuration or reconfiguration during service flow or/service sub-flow level establishment or reconfiguration. In an embodiment, the method may further include receiving a request for user equipment level or service flow or service sub-flow level network functions or services configuration or reconfiguration from at least one of the network access elements, and indicating the user equipment level or service flow or service sub-flow level network functions or services configuration or reconfiguration to the at least one of the network access elements.

According to certain embodiments, user equipment level or service flow or service sub-flow level network functions or services configuration is implicitly or explicitly indicated, wherein the implicit indication is based on whether multi-connectivity is activated to the user equipment or service flow or service sub-flow or the explicit indication is provided in at least one of a control signaling message, data packet header or control packet data unit. In an embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information.

Another embodiment is directed to an apparatus, which may include at least one processor and at least one memory comprising computer program code. The at least one memory and the computer program code are configured, with the at least one processor, to cause the apparatus at least to decide to customize or enhance service capability of a service network, wherein the service network comprises a plurality of network access elements, and to configure at least one certain network function or service flexibly among the network access elements of the service network.

In an embodiment, the at least one certain network function may comprise a function of a radio protocol stack. According to one embodiment, the configuring comprises adding or removing on-the-fly a piece of add-on software corresponding to the at least one certain network function or service of the radio protocol stack.

In some embodiments, the at least one memory and the computer program code are further configured, with the at least one processor, to cause the apparatus at least to receive a network functions or services support capability indication from a network access element. In one embodiment, the network functions or services support capability indication may be received before deciding to customize or enhance the service capability.

According to one embodiment, the at least one memory and the computer program code are further configured, with the at least one processor, to cause the apparatus at least to, when one of the network access elements of the service network performs network functions or services self-reconfiguration, receive a cell level network functions or services reconfiguration indication from said one of the network access elements. In some embodiments, the at least one memory and the computer program code are further configured, with the at least one processor, to cause the apparatus at least to indicate or receive user equipment level network functions or services configuration or reconfiguration during user equipment connection establishment or reconfiguration.

According to certain embodiments, the at least one memory and the computer program code are further configured, with the at least one processor, to cause the apparatus at least to indicate or receive service flow or service sub-flow level network functions or services configuration or reconfiguration during service flow or/service sub-flow level establishment or reconfiguration. In an embodiment, the at least one memory and the computer program code are further configured, with the at least one processor, to cause the apparatus at least to receive a request for user equipment level or service flow or service sub-flow level network functions or services configuration or reconfiguration from at least one of the network access elements, and to indicate the user equipment level or service flow or service sub-flow level network functions or services configuration or reconfiguration to the at least one of the network access elements.

In some embodiments, user equipment level or service flow or service sub-flow level network functions or services configuration is implicitly or explicitly indicated, wherein the implicit indication is based on whether multi-connectivity is activated to the user equipment or service flow or service sub-flow or the explicit indication is provided in at least one of a control signaling message, data packet header or control packet data unit.

According to one embodiment, the service network may be a 5G network. In an embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information.

Another embodiment is directed to an apparatus, which may include deciding means for deciding to customize or enhance service capability of a service network. The service network comprises a plurality of network access elements. The apparatus may also include configuring means for configuring at least one certain network function or service flexibly among the network access elements of the service network.

In one embodiment, the at least one certain network function may be a function of a radio protocol stack. In some embodiments, the configuring means may comprise means for adding or removing on-the-fly a piece of add-on software corresponding to the at least one certain network function or service of the radio protocol stack.

According to an embodiment, the apparatus may further include means for receiving a network functions or services support capability indication from at least one of the network access elements. In some embodiments, the network functions or services support capability indication may be received before deciding to customize or enhance the service capability.

In an embodiment, the apparatus may also include, when one of the network access elements of the service network performs network functions or services self-reconfiguration, means for receiving a cell level network functions or services reconfiguration indication from said one of the network access elements. According to some embodiments, the apparatus may further include means for indicating or receiving user equipment level network functions or services configuration or reconfiguration during user equipment connection establishment or reconfiguration.

According to an embodiment, the apparatus may also include means for indicating or receiving service flow or service sub-flow level network functions or services configuration or reconfiguration during service flow or/service sub-flow level establishment or reconfiguration. In an embodiment, the apparatus may further include means for receiving a request for user equipment level or service flow or service sub-flow level network functions or services configuration or reconfiguration from at least one of the network access elements, and means for indicating the user equipment level or service flow or service sub-flow level network functions or services configuration or reconfiguration to the at least one of the network access elements.

According to certain embodiments, user equipment level or service flow or service sub-flow level network functions or services configuration is implicitly or explicitly indicated, wherein the implicit indication is based on whether multi-connectivity is activated to the user equipment or service flow or service sub-flow or the explicit indication is provided in at least one of a control signaling message, data packet header or control packet data unit. In an embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information.

Another embodiment is directed to a method, which may include transmitting, by a network access element, a network functions or services support capability indication to a network entity. The method may also include receiving network functions or services configuration or reconfiguration information, and performing on-the-fly cell level network functions or services configuration or reconfiguration.

In an embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information. According to one embodiment, the transmitting comprises transmitting the network functions or services support capability indication during deployment, switch-on, activation, or reactivation of the network access element.

In one embodiment, the configuration or reconfiguration information comprises configuration location of each radio protocol layer for at least one of the network access elements or user equipment or service flow or service sub-flows basis. For example, the on-the-fly cell level network functions or services configuration or reconfiguration may be based on at least one of: the cell load, available front or back-haul capacity, or the user services served by the cell. According to an embodiment, the on-the-fly cell level network functions or services configuration or reconfiguration is performed based on pre-configured policies and/or rules.

According to one embodiment, the method may also include indicating to the network entity the network functions or services configuration each time the configuration changes. For example, in one embodiment, the on-the-fly cell level network functions or services configuration or reconfiguration may be performed based on network functions or services provided by a software download from a server.

Another embodiment is directed to an apparatus, which may include at least one processor and at least one memory comprising computer program code. The at least one memory and the computer program code are configured, with the at least one processor, to cause the apparatus at least to transmit a network functions or services support capability indication to a cloud, to receive or obtain cell level network functions or services configuration or reconfiguration information, and to perform on-the-fly cell level network functions or services configuration or reconfiguration.

In one embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information. According to an embodiment, the network entity may comprise a 5G network entity where a core network control entity, radio access network (RAN) aggregator, or self-organizing network (SON) and operations and management (O&M) server is located.

Another embodiment is directed to an apparatus, which may include transmitting means for transmitting or providing a network functions or services support capability indication to a network entity. The apparatus may also include receiving means for receiving or obtaining cell level network functions or services configuration or reconfiguration information, and performing means for performing on-the-fly cell level network functions or services configuration or reconfiguration.

In an embodiment, the network functions or services support capability indication comprises at least one of an indication of whether higher layer protocol stack is supported or not, whether in-service flow differentiation scheduler supported or not, open information on predefined general purpose computing platform or application interface which is not vendor sensitive information. According to one embodiment, the transmitting means comprises means for transmitting the network functions or services support capability indication during deployment, switch-on, activation, or re-activation of the network access element.

In one embodiment, the configuration or reconfiguration information comprises configuration location of each radio protocol layer for at least one of the network access elements or user equipment or service flow or service sub-flows basis. For example, the on-the-fly cell level network functions or services configuration or reconfiguration may be based on at least one of: the cell load, available front or back-haul capacity, or the user services served by the cell. According to an embodiment, the on-the-fly cell level network functions or services configuration or reconfiguration is performed based on pre-configured policies and/or rules.

According to one embodiment, the apparatus may also include means for indicating to the network entity the network functions or services configuration each time the configuration changes. For example, in one embodiment, the on-the-fly cell level network functions or services configuration or reconfiguration may be performed based on network functions or services provided by a software download from a server.

Another embodiment is directed to a method, which may include receiving at least one signal of user equipment level radio protocol stack configuration or user equipment level radio protocol stack reconfiguration or service flow or service sub-flow level radio protocol configuration or service flow or service sub-flow level radio protocol reconfiguration. The method may also include configuring or reconfiguring the user equipment level radio protocol stack or the service flow or service sub-flow level radio protocol according to the received signal.

In an embodiment, the user equipment level radio protocol stack is configured based on at least one of a cell level radio protocol configuration or reconfiguration or a profile of the user equipment or a serving cell or network load. In one embodiment, the service flow or service sub-flow level radio protocol stack configuration or reconfiguration is part of service flow or service sub-flow establishment of a network entity.

According to an embodiment, the service flow or service sub-flow level radio protocol configuration or the service flow or service sub-flow level radio protocol reconfiguration is based on service flow or service sub-flow quality of service. In an embodiment, the service flow or service sub-flow level radio protocol configuration or the service flow or service sub-flow level radio protocol reconfiguration is indicated based on if multi-connectivity is activated to the user equipment service flow or service sub-flow.

Another embodiment is directed to an apparatus, which may include at least one processor and at least one memory comprising computer program code. The at least one memory and the computer program code are configured, with the at least one processor, to cause the apparatus at least to receive at least one signal of user equipment level radio protocol stack configuration or user equipment level radio protocol stack reconfiguration or service flow or service sub-flow level radio protocol configuration or service flow or service sub-flow level radio protocol reconfiguration, and to configure or reconfiguring the user equipment level radio protocol stack or the service flow or service sub-flow level radio protocol according to the received signal.

In an embodiment, the user equipment level radio protocol stack is configured based on at least one of a cell level radio protocol configuration or reconfiguration or a profile of the user equipment or a serving cell or network load. According to one embodiment, the service flow or service sub-flow level radio protocol stack configuration or reconfiguration is part of service flow or service sub-flow establishment of a network entity.

In one embodiment, the service flow or service sub-flow level radio protocol configuration or the service flow or service sub-flow level radio protocol reconfiguration is based on service flow or service sub-flow quality of service. According to an embodiment, the service flow or service sub-flow level radio protocol configuration or the service flow or service sub-flow level radio protocol reconfiguration is indicated based on if multi-connectivity is activated to the user equipment service flow or service sub-flow.

Another embodiment is directed to an apparatus, which may include receiving means for receiving at least one signal of user equipment level radio protocol stack configuration or user equipment level radio protocol stack reconfiguration or service flow or service sub-flow level radio protocol configuration or service flow or service sub-flow level radio protocol reconfiguration, and configuring means for configuring or reconfiguring the user equipment level radio protocol stack or the service flow or service sub-flow level radio protocol according to the received signal.

In an embodiment, the user equipment level radio protocol stack is configured based on at least one of a cell level radio protocol configuration or reconfiguration or a profile of the user equipment or a serving cell or network load. In one embodiment, the service flow or service sub-flow level radio protocol stack configuration or reconfiguration is part of service flow or service sub-flow establishment of a network entity.

According to an embodiment, the service flow or service sub-flow level radio protocol configuration or the service flow or service sub-flow level radio protocol reconfiguration is based on service flow or service sub-flow quality of service. In an embodiment, the service flow or service sub-flow level radio protocol configuration or the service flow or service sub-flow level radio protocol reconfiguration is indicated based on if multi-connectivity is activated to the user equipment service flow or service sub-flow.

### BRIEF DESCRIPTION OF THE DRAWINGS

For proper understanding of the invention, reference should be made to the accompanying drawings, wherein:

FIG. 1 illustrates an example of flexible RAN protocol stack for different deployment scenarios;

FIG. 2 illustrates a signaling diagram, according to one embodiment;

FIG. 3a illustrates a block diagram of an apparatus according to an embodiment;

FIG. 3b illustrates a block diagram of an apparatus according to another embodiment;

FIG. 3c illustrates a block diagram of an apparatus according to another embodiment;

FIG. 4a illustrates a flow diagram of a method according to one embodiment;

FIG. 4b illustrates a flow diagram of a method according to another embodiment; and

FIG. 4c illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for support of flexible radio protocol in 5G radio access network (RAN), as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

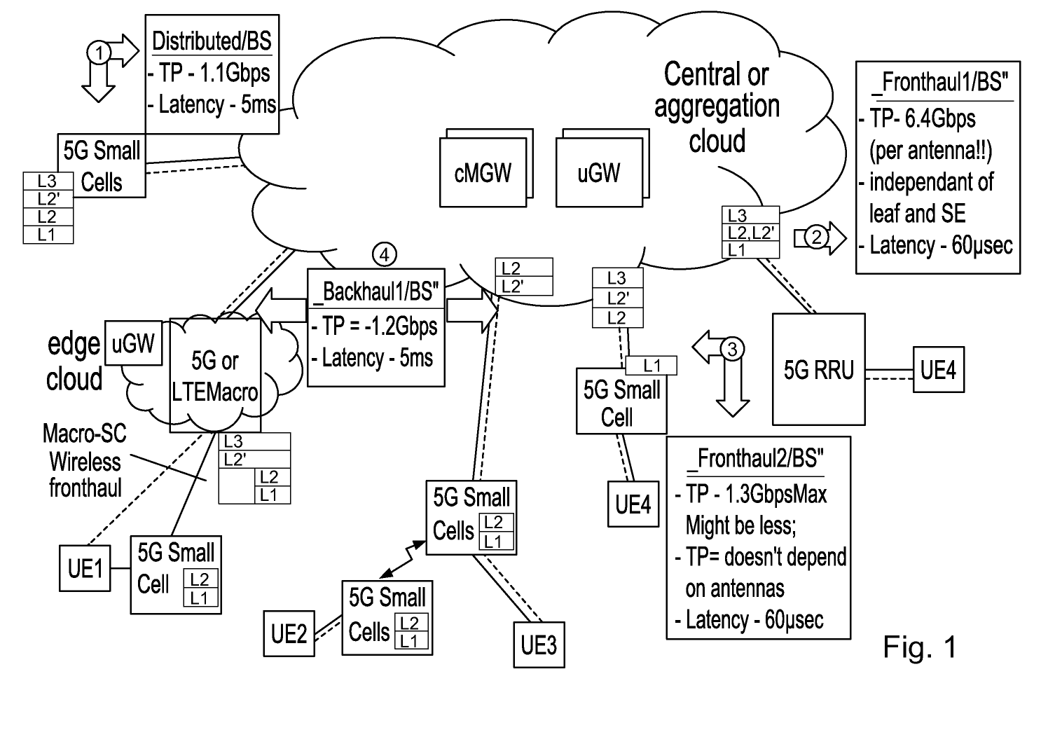

Flexible network architecture in 5G aims to develop an adaptive (de)composition and allocation of mobile network functions to optimize the network performance on a per-service and per-scenario basis. 5G RAN architecture may also provide flexible radio protocol stacks to allow efficient support of different deployment scenarios, as illustrated in FIG. 1. In particular, FIG. 1 illustrates an example of flexible RAN protocol stack for different deployment scenarios. Related to the flexible radio protocol stacks there may be also a need for coordination functions between flexible radio protocol stacks located in separate network entities. Those coordination functions could be either parts of the flexible radio protocol stacks or additional functions. The coordination functions may take care of activating/deactivating specific parts of protocol stacks and handling the inputs and outputs of protocol stacks.

In such a flexible per-service per-scenario 5G network paradigm, as illustrated in FIG. 1, the following observations can be made:
Each 5G small cell access point (AP) may have different capability on support of radio protocol stack (e.g., the low cost APs may only support L1 and lower layer of L2 protocol but some APs targeted on stand-alone network deployment may support full radio protocol stack).
Radio protocol stack configuration of 5G small cell AP may need to change dynamically based on flexible network topology due to, for example, available front/back-haul capacity and/or based on the requested user services (e.g., full radio protocol stack may be configured in 5G AP if local services or services with low latency requirement like V2X is requested, while lower radio protocol stack may be configured in 5G AP if uGW is involved in serving the user services in order to fully explore the advantages of cloud technology).
Service flow/in-service flow differentiation may also require different radio protocol stack configuration between different UEs served by same 5G AP or same UE served by different APs in case of multi-connectivity.
The open interface between 5G AP and the cloud may be needed to support the flexible radio protocol stack configuration for better multi-vendor inter-operability support.
Future network elements as well as functions may be implemented using, for example, general purpose computing platforms which allows for on-the-fly flexible customization or enhancement of UE and RAN service capability with, for example, on-the-fly on-demand software download and execution of an add-on piece.

Focusing on the problem of how to support such flexible radio protocol stack configuration in an adaptive and efficient way, an embodiment of the invention provides the corresponding signalling mechanism on both AP and UE level.

There is an eNB Configuration Update and Cell Reconfiguration procedure defined in LTE and Wideband Code Division Multiple Access (WCDMA) systems, respectively. However, due to the fixed functional allocation in each network element in current LTE or WCDMA systems, the eNB Configuration Update procedure in LTE only includes the information of supported tracking area, closed subscriber group (CSG) identification (IDs) and paging related discontinuous reception (DRX) default values of eNB, and Cell Reconfiguration in WCMDA system is mainly on physical layer related configuration such as transmission power, synchronization, MIMO etc. No such flexible radio protocol stack related configuration has been supported in current mobile network.

Certain embodiments of the invention provide a signalling mechanism for supporting flexible radio protocol stack configuration which can be adapted to the deployment scenario, the flexible network topology, the cell load including the availability of front/back-haul capacity, the served user services type or quality of service (QoS), etc. Herein, the radio protocol stack configuration mainly refers to configuring the location (e.g., in 5G AP or in the cloud) of each radio protocol layer for the 5G AP/UE/service flow/sub-flows, which is different from the radio protocol configuration such as Network Convergence Sub-layer (NCS)/packet data convergence protocol (PDCP), Radio Convergence Sub-layer (RCS)/radio link control (RLC) related parameter configuration in the prior arts.

According to an embodiment, during deployment, switch-on, or (re-)activation, a 5G AP may indicate the capability of radio protocol stack support to the cloud where the core network (CN) control entity (e.g., controlling media gateway (cMGW)) or RAN aggregator (e.g., multi-controller) or self-organizing network (SON) and operations and management (O&M) server is located. The indication of the capability of radio protocol stack support may include, for example, an indication of whether higher layer protocol stack is supported or not, whether in-service flow differentiation scheduler supported or not, open information on predefined general purpose computing platform or application interface which is not vendor sensitive information, etc.

In one embodiment, during operation, a 5G AP may be configured on-the-fly with the different radio protocol stack configuration mode even though the AP has full radio protocol stack capability. The configuration may be based on at least one of or any combination of the following: 1) the cell load (e.g., in-service flow differentiated scheduling in lower radio protocol stack may not be configured in low cell load case as high throughput and low latency can be expected for every service flows in this case), 2) available front/back-haul capacity (e.g., in case of high front/back-haul capacity, AP may be configured to have lower layer protocol stack only so that advantage of cloud technology can be better explored by implementing higher layer protocol stack in the cloud), 3) the user services served by the cell (e.g., full protocol stack may be configured if mainly local services with low latency requirement are requested by the UEs served in the cell. The available front/back-haul capacity characteristics information may be further divided into classes which will define the capacity/latency ranges compared to possible protocol split (i.e. a certain protocol split will require a specific capacity/latency on the front/back-haul). Or the lower layer protocol stack may be configured in each involved AP if most of user services served in the cells request multi-connectivity so that the transmission on multi-connectivity can be more efficiently coordinated if higher layer protocol stack is located in the cloud). The radio protocol stack configuration of 5G AP may be from the cloud controller, CN control entity (e.g. cMGW) or RAN aggregator or O&M based on traffic monitoring or some report from 5G AP. Alternatively, the 5G AP may self-configure/-change the radio protocol stack based on pre-configured policies/rules. In this case, the 5G AP may need to indicate the radio protocol stack configuration to the cloud every time when the configuration changes.

In some cases, the serving network may decide to customize or enhance service capability of a serving 5G AP as well as UE being served by the serving 5G AP with on-the-fly add or remove a piece of add-on software corresponding to certain network functions or services of the radio protocol stack. This is referred to as on-the-fly flexible configuration and control of software enabled radio access capability for both serving 5G AP and UE which can be considered as a SON feature for 5G.

If full radio protocol stack is configured in the 5G AP during operation, the UE or service flow or sub-service flow specific radio protocol stack configuration may be performed when radio resource control (RRC) connection/service flow is established or sub-flow is identified. To support the UE/service flow/sub-flow level radio protocol stack configuration, radio protocol stack split request or indication signalling as UE level radio protocol stack (re-)configuration procedure may be introduced between 5G AP and the cloud. The signalling may be a standalone message or embedded to the UE/service flow establishment message. As another option, in-band signalling with service flow packet header masking or control-packet data unit (PDU) may be introduced without separate control plane message. The UE/service flow/sub-flow specific radio protocol stack configuration in the network side may be either invisible or visible to the UE. For the latter case, UE access stratum (AS) and non-access stratum (NAS) procedure may be enhanced or adapted to the split radio protocol stack configuration (e.g., higher layer protocol is in the cloud and lower layer protocol is in the 5G AP).

In some cases, the radio protocol stack configuration may also include the option of reactivation/deactivation or enabling/disabling of some features, functions or services of certain protocol stacks specific to a cell served by an 5G AP, or specific to at least some class of UEs or services being served by the cell, or specific to individual UE or SF/sub-flow of an individual UEs served by the cell.

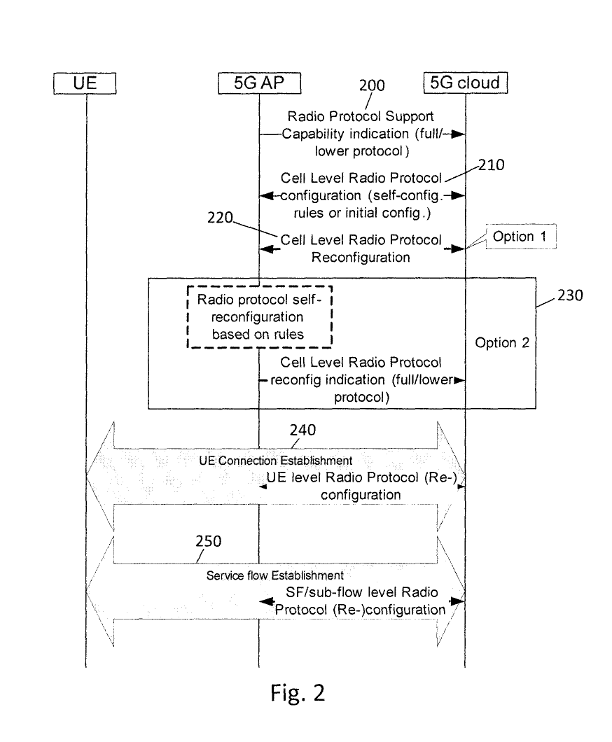

FIG. 2 illustrates one example of signalling procedures, according to an embodiment. For the SF/sub-flow level radio protocol configuration, only the out-of-band signalling is shown in FIG. 2. However, in some embodiments, the packet marking can also be used, for example the packet header may indicate that it is an IP packet or PDCP/NCS or RLC/RCS PDU so that 5G AP knows if higher layer protocol stack should be applied to the packet or not.

As illustrated in FIG. 2, at 200, the 5G AP may transmit or signal a radio protocol support capability indication to the 5G cloud. For example, the radio protocol support capability indication may indicate whether higher layer protocol stack is supported or not, whether in-service flow differentiation scheduler supported or not, open information on predefined general purpose computing platform or application interface which is not vendor sensitive information, etc.

At 210, the 5G AP may receive or obtain cell level radio protocol configuration, which may be, for example, self-configuration rules or initial configuration information. As a first option, at 220, the 5G AP may perform cell level radio protocol reconfiguration if the configuration information is coming from the 5G cloud. Alternatively, at 230, the 5G AP may perform radio protocol self-reconfiguration based on the self-configuration rules that the 5G cloud has configured and may indicate to the 5G cloud the cell level radio protocol stack reconfiguration each time the configuration changes.

At 240, the 5G cloud may perform UE connection establishment which may include performing UE level radio protocol stack configuration or reconfiguration. The configuration may be performed when UE attaches to the network. The UE level radio protocol stack may be configured based on the cell level radio protocol configuration of the UE's serving 5G AP, the UE's profile, the serving cell or network load etc. At 250, the 5G cloud may perform service flow (SF)/sub-flow establishment which may include performing SF/sub-flow level radio protocol stack configuration or reconfiguration.

The service flow or sub-flow specific radio protocol stack configuration may be based on service flow/sub-flow QoS. For instance, for the service flow with high throughput and high reliability requirement, multiple radio links from different APs may be established for transmission of the service flow. In this case, higher layer radio protocol may be configured in the cloud for more efficient coordination and control of the data transmission. In addition, UE or SF/sub-flow level radio protocol configuration may also be implicitly indicated, for example, based on if multi-connectivity is activated to the UE/SF/sub-flow (e.g., multi-connectivity activation means higher layer protocol is located in the cloud for the UE/DF/sub-flow and vice-versa).

According to one implementation option, the protocol stacks may be provided by software downloads in the initial configuration. For instance, a customer (e.g., operator) can buy an AP either with full configuration including all protocol stacks or with a basic functionality which will establish the link to a software download server. The software download server could be, for example, in the cloud where RAN aggregator or cMGW is located, or O&M server if it is separate network entity. Through the link established using the basic functionality, the AP capabilities may be set or checked, which then could control the download options accordingly. In the software download approach, the on-the-fly configuration of the radio protocol stack will be very easy. The software download approach may also support the activation of certain protocol stack options if all the stacks are downloaded.

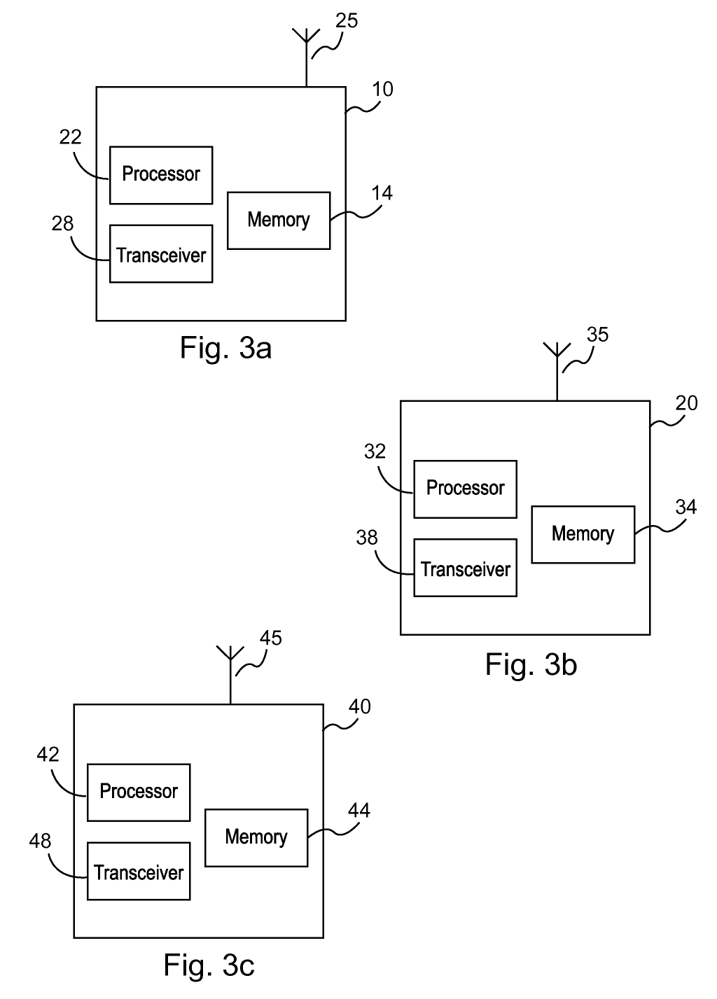

FIG. 3a illustrates an example of an apparatus 10 according to an embodiment. In an embodiment, apparatus 10 may be a node, host, or server in a communications network or serving such a network. For example, in certain embodiments, apparatus 10 may be a network node or control entity for a radio access network, such as a 5G network. In certain embodiments, apparatus 10 may be a control entity located in the 5G cloud, such as CN control entity (e.g., cMGW) or RAN aggregator (e.g., multi-controller) or self-organizing network (SON) and operations and management (O&M) server. However, in other embodiments, apparatus 10 may be other components within a radio access network. It should be noted that one of ordinary skill in the art would understand that apparatus 10 may include components or features not shown in FIG. 3a.

As illustrated in FIG. 3a, apparatus 10 includes a processor 22 for processing information and executing instructions or operations. Processor 22 may be any type of general or specific purpose processor. While a single processor 22 is shown in FIG. 3a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, in one embodiment, apparatus 10 may be a network entity or control entity in a service network cloud, such as a 5G cloud, for example. According to an embodiment, apparatus 10 may be controlled by memory 14 and processor 22 to decide to customize or enhance service capability of the service network. The service network may include one or more network access elements, such as serving 5G APs. Accordingly, apparatus 10 is capable of customizing or enhancing the service capability of serving 5G APs and/or UE being served by a 5G AP. In this embodiment, when apparatus 10 decides to customize or enhance the service capabilities, apparatus 10 may then be controlled by memory 14 and processor 22 to configure and/or distribute certain network functions or services flexibly among the network access elements of the service network. In an embodiment, the certain network functions or services may include functions of a radio protocol stack. For example, apparatus 10 may be controlled to add or remove on-the-fly a piece of add-on software corresponding to the certain network functions or services of the radio protocol stack.

In certain embodiments, apparatus 10 may also be controlled by memory 14 and processor 22 to receive a network functions or services support capability indication (e.g., radio protocol support capability indication) from the network access element (e.g., 5G AP). In an embodiment, the network functions or services support capability indication may be received before deciding to customize or enhance the service capabilities. According to some embodiments, when one of the network access elements (e.g., a 5G AP) performs network functions or services self-reconfiguration, apparatus 10 may be controlled by memory 14 and processor 22 to receive a cell level network functions or services reconfiguration indication from the one of the network access elements.

In an embodiment, apparatus 10 may also be controlled by memory 14 and processor 22 to indicate or receive UE level network functions or services configuration or reconfiguration during UE connection establishment or reconfiguration. According to one embodiment, apparatus 10 may be further controlled by memory 14 and processor 22 to indicate or receive SF/sub-flow level network functions or services configuration or reconfiguration during SF/sub-flow level establishment or reconfiguration. According to another embodiment, apparatus 10 may be further controlled by memory 14 and processor 22 to receive a request for UE level or SF/sub-flow level network functions or services configuration or reconfiguration from at least one of the network elements, and to indicate the UE level or SF/sub-flow level network functions or services configuration or reconfiguration to the at least one of the network elements. In certain embodiments, UE or SF/sub-flow level network functions or services configuration may be explicitly or implicitly indicated, for example, based on if multi-connectivity is activated to the UE/SF/sub-flow.

According to an embodiment, the network functions or services support capability indication comprises at least one of an indication of whether higher layer protocol stack is supported or not, whether in-service flow differentiation scheduler is supported or not, open information on predefined general purpose computing platform or application interface which is not vendor sensitive information.

FIG. 3b illustrates an example of an apparatus 20 according to another embodiment. In an embodiment, apparatus 20 may be a node, host, or server in a communications network or serving such a network. For instance, in some embodiments, apparatus 20 may be a base station or access point for a communications network, such as a 5G AP. It should be noted that one of ordinary skill in the art would understand that apparatus 20 may include components or features not shown in FIG. 3b.

As illustrated in FIG. 3b, apparatus 20 includes a processor 32 for processing information and executing instructions or operations. Processor 32 may be any type of general or specific purpose processor. While a single processor 32 is shown in FIG. 3b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a network access element, such as a base station, eNB, or a 5G AP. In this embodiment, apparatus 20 may be controlled by memory 34 and processor 32 to transmit or provide a network functions or services support capability indication (e.g., radio protocol support capability indication) to a network entity. For example, the network entity may be comprised in a cloud, such as a 5G cloud where a core network control entity, RAN aggregator, or SON and O&M server is located. In an embodiment, the transmitting of the radio protocol support capability indication may be during deployment, switch-on, activation, or re-activation of apparatus 20. In certain embodiments, the network functions or services support capability indication may include an indication of whether higher layer protocol stack is supported or not, whether in-service flow differentiation scheduler supported or not, open information on predefined general purpose computing platform or application interface which is not vendor sensitive information, etc.

In some embodiments, apparatus 20 may be controlled by memory 34 and processor 32, during operation, to receive or obtain cell level network functions or services configuration or reconfiguration information. According to certain embodiments, the configuration or reconfiguration information may include configuration location of each radio protocol layer for 5G AP/UE/service flow/sub-flows.

According to one embodiment, apparatus 20 may then be controlled by memory 34 and processor 32 to perform on-the-fly cell level network functions or services configuration or reconfiguration. In an embodiment, the on-the-fly cell level radio protocol stack configuration or reconfiguration may be based, for example, on at least one of: the cell load, available front/back-haul capacity, or the user services served by the cell.

In another embodiment, the on-the-fly cell level network functions or services configuration or reconfiguration may be performed based on pre-configured policies and/or rules. According to one embodiment, apparatus 20 may then be controlled by memory 34 and processor 32 to indicate to the network entity (e.g., in the 5G cloud) the network functions or services configuration each time the configuration changes.

In certain example embodiments, the on-the-fly cell level network functions or services configuration or reconfiguration may be performed based on the protocol stacks provided by a software download in the initial configuration, for example where a customer (e.g., operator) may buy an AP either with full configuration including all protocol stacks or with a basic functionality which will establish the link to a software download server.

FIG. 3c illustrates an example of an apparatus 40 according to another embodiment. In an embodiment, apparatus 40 may be a node, host, or server in a communications network or serving such a network. For instance, in some embodiments, apparatus 40 may be a mobile device or user equipment (UE) associated with a communications network. It should be noted that one of ordinary skill in the art would understand that apparatus 40 may include components or features not shown in FIG. 3c.

As illustrated in FIG. 3c, apparatus 40 includes a processor 42 for processing information and executing instructions or operations. Processor 42 may be any type of general or specific purpose processor. While a single processor 42 is shown in FIG. 3c, multiple processors may be utilized according to other embodiments. In fact, processor 42 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 40 may further include or be coupled to a memory 44 (internal or external), which may be coupled to processor 42, for storing information and instructions that may be executed by processor 42. Memory 44 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 44 may be comprised of any combination of random access memory (RAM), read only memory (ROM), static storage such as a magnetic or optical disk, or any other type of non-transitory machine or computer readable media. The instructions stored in memory 44 may include program instructions or computer program code that, when executed by processor 42, enable the apparatus 40 to perform tasks as described herein.

In some embodiments, apparatus 40 may also include or be coupled to one or more antennas 45 for transmitting and receiving signals and/or data to and from apparatus 40. Apparatus 40 may further include a transceiver 48 configured to transmit and receive information. For instance, transceiver 48 may be configured to modulate information on to a carrier waveform for transmission by the antenna(s) 45 and demodulate information received via the antenna(s) 45 for further processing by other elements of apparatus 40. In other embodiments, transceiver 48 may be capable of transmitting and receiving signals or data directly.

Processor 42 may perform functions associated with the operation of apparatus 40 including, without limitation, precoding of antenna gain/phase parameters, encoding and decoding of individual bits forming a communication message, formatting of information, and overall control of the apparatus 40, including processes related to management of communication resources.

In an embodiment, memory 44 stores software modules that provide functionality when executed by processor 42. The modules may include, for example, an operating system that provides operating system functionality for apparatus 40. The memory may also store one or more functional modules, such as an application or program, to provide additional functionality for apparatus 40. The components of apparatus 40 may be implemented in hardware, or as any suitable combination of hardware and software.

As mentioned above, according to one embodiment, apparatus 20 may be a mobile device or UE. In this embodiment, apparatus 40 may be controlled by memory 44 and processor 42 to receive at least one signal of user equipment level radio protocol stack configuration or user equipment level radio protocol stack reconfiguration or service flow or service sub-flow level radio protocol configuration or service flow or service sub-flow level radio protocol reconfiguration. Apparatus 40 may be further controlled by memory 44 and processor 42 to configure or reconfiguring the user equipment level radio protocol stack or the service flow or service sub-flow level radio protocol according to the received signal.

In an embodiment, the user equipment level radio protocol stack may be configured based on at least one of a cell level radio protocol configuration or reconfiguration or a profile of the user equipment or a serving cell or network load. According to one embodiment, the service flow or service sub-flow level radio protocol stack configuration or reconfiguration may be part of service flow or service sub-flow establishment of a network entity. In one embodiment, the service flow or service sub-flow level radio protocol configuration or the service flow or service sub-flow level radio protocol reconfiguration may be based on service flow or service sub-flow quality of service. According to an embodiment, the service flow or service sub-flow level radio protocol configuration or the service flow or service sub-flow level radio protocol reconfiguration is indicated based on if multi-connectivity is activated to the user equipment service flow or service sub-flow.

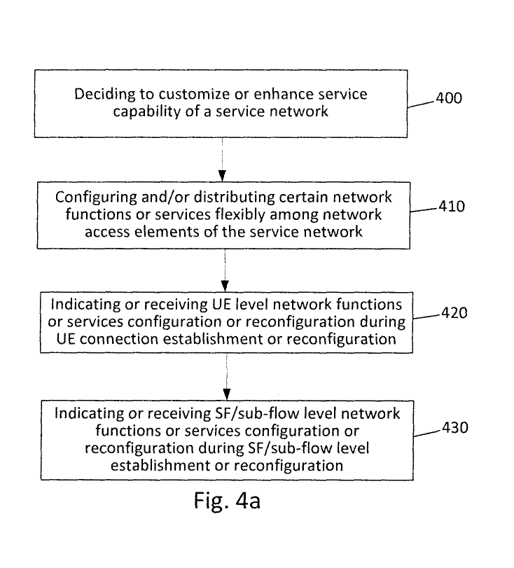

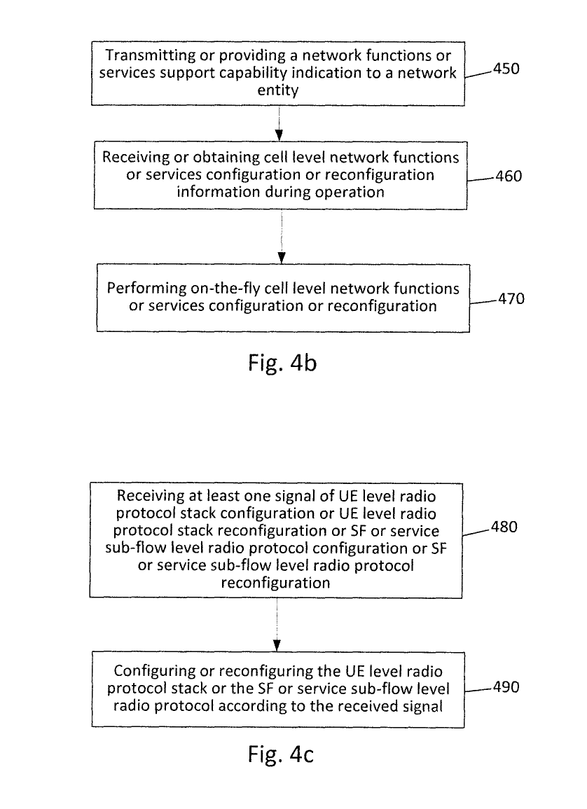

FIG. 4a illustrates an example flow diagram of a method, according to one embodiment of the invention. In one embodiment, the method of FIG. 4a may be performed by a network entity or control entity in a service network cloud, such as a 5G cloud, for example. The method may include, at 400, deciding to customize or enhance service capability of a service network. The service network may include one or more network access elements, such as serving 5G AP(s). The method may then include, at 410, configuring and/or distributing certain network functions or services flexibly among the network access elements of the service network, to enhance the service capability of the network elements and/or a UE. In an embodiment, the distributing may include adding or removing, on-the-fly, a piece of add-on software corresponding to the certain network functions or services of the radio protocol stack.

In certain embodiment, the method may include receiving a network functions or services support capability indication from the service network (e.g., 5G AP). According to an example embodiment, the step of receiving the network functions or services support capability indication may occur before deciding to customize or enhance the service capabilities. In one embodiment, when one of the network access elements performs radio protocol self-reconfiguration, the method may include receiving a cell level network functions or services reconfiguration indication from the one of the network access elements.

As illustrated in FIG. 4a, the method may include, at 420, indicating or receiving UE level network functions or services configuration or reconfiguration during UE connection establishment or reconfiguration. In an embodiment, the method may include, at 430, indicating or receiving SF/sub-flow level network functions or services configuration or reconfiguration during SF/sub-flow level establishment or reconfiguration. In another embodiment, the method may include receiving a request for UE level or SF/sub-flow level network functions or services configuration or reconfiguration from at least one of the network elements, and indicating the UE level or SF/sub-flow level network functions or services configuration or reconfiguration to the at least one of the network elements. According to one embodiment, the UE or SF/sub-flow level radio protocol configuration may be explicitly or implicitly indicated based on whether multi-connectivity is activated to the UE/SF/sub-flow.

FIG. 4b illustrates an example flow diagram of a method, according to another embodiment of the invention. In one embodiment, the method of FIG. 4b may be performed by a network access element, such as a base station, eNB, or access point, such as a 5G AP. As illustrated in FIG. 4b, the method may include, at 450, transmitting or providing a network functions or services support capability indication to a network entity. The network entity may be comprised in a cloud, such as a 5G cloud where a core network control entity, radio access network (RAN) aggregator, or self-organizing network (SON) and operations and management (O&M) server is located.

In an embodiment, the method may also include, at 460, receiving or obtaining cell level network functions or services configuration or reconfiguration information during operation. At 470, the method may include performing on-the-fly cell level network functions or services configuration or reconfiguration.

FIG. 4c illustrates a flow diagram of a method, according to another embodiment. In one embodiment, the method of FIG. 4c may be performed by a UE, for example. The method may include, at 480, receiving at least one signal of UE level radio protocol stack configuration or UE level radio protocol stack reconfiguration or service flow or service sub-flow level radio protocol configuration or service flow or service sub-flow level radio protocol reconfiguration. The method may then include, at 490, configuring or reconfiguring the UE level radio protocol stack or the service flow or service sub-flow level radio protocol according to the received signal.

According to one embodiment, the network functions or services support capability indication may include at least one of an indication of whether higher layer protocol stack is supported or not, whether in-service flow differentiation scheduler supported or not, open information on predefined general purpose computing platform or application interface which is not vendor sensitive information.

In certain embodiments, the transmitting may include transmitting the radio protocol support capability indication during deployment, switch-on, activation, or re-activation of the network access element (e.g., 5G AP). According to one embodiment, the configuration or reconfiguration information may include configuration location of each radio protocol layer for 5G AP/UE/service flow/sub-flows. In an embodiment, the on-the-fly cell level network functions or services configuration or reconfiguration may be based on at least one of: the cell load, available front/back-haul capacity, or the user services served by the cell.

In some embodiments, the on-the-fly cell level network functions or services configuration or reconfiguration may be performed based on pre-configured policies and/or rules. According to an embodiment, the method may also include indicating to the cloud the network functions or services configuration each time the configuration changes. In certain embodiments, the on-the-fly cell level network functions or services configuration or reconfiguration is performed based on protocol stacks provided by a software download from a server. In an embodiment, the on-the-fly cell level network functions or services configuration may include on-the-fly cell level radio protocol stack configuration.

According to embodiments, programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality of any method or apparatus described herein may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that may be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-45. (canceled)

46. An apparatus, comprising:
at least one processor; and
at least one memory comprising computer program code,
the at least one memory and the computer program code are configured, with the at least one processor, to cause the apparatus at least to
decide to customize or enhance service capability of a service network, wherein the service network comprises a plurality of network access elements; and
configure at least one certain network function or service flexibly among the network access elements of the service network.

47. The apparatus according to claim 46, wherein said at least one certain network function comprises function of a radio protocol stack.

48. The apparatus according to claim 46, wherein the configuring comprises adding or removing on-the-fly a piece of add-on software corresponding to the at least one certain network function or service of the radio protocol stack.

49. The apparatus according to claim 46, wherein the at least one memory and the computer program code are further configured, with the at least one processor, to cause the apparatus at least to:
receive a network functions or services support capability indication from the network access element.

50. The apparatus according to claim 49, wherein the network functions or services support capability indication is received before deciding to customize or enhance the service capability.

51. The apparatus according to claim 46, wherein the at least one memory and the computer program code are further configured, with the at least one processor, to cause the apparatus at least to:
when one of the network access elements of the service network performs network functions or services self-reconfiguration, receive a cell level network functions or services reconfiguration indication from said one of the network access elements.

52. The apparatus according to claim 46, wherein the at least one memory and the computer program code are further configured, with the at least one processor, to cause the apparatus at least to:
indicate or receive user equipment level network functions or services configuration or reconfiguration during user equipment connection establishment or reconfiguration.

53. The apparatus according to claim 46, wherein the at least one memory and the computer program code are further configured, with the at least one processor, to cause the apparatus at least to:
indicate or receive service flow or service sub-flow level network functions or services configuration or reconfiguration during service flow or/service sub-flow level establishment or reconfiguration.

54. The apparatus according to claim 46, wherein the at least one memory and the computer program code are further configured, with the at least one processor, to cause the apparatus at least to:
receive a request for user equipment level or service flow or service sub-flow level network functions or services configuration or reconfiguration from at least one of the network access elements; and
indicate the user equipment level or service flow or service sub-flow level network functions or services configuration or reconfiguration to the at least one of the network access elements.

55. The apparatus according to claim 52, wherein the user equipment level or service flow or service sub-flow level network functions or services configuration is implicitly or explicitly indicated, wherein the implicit indication is based on whether multi-connectivity is activated to the user equipment or service flow or service sub-flow or the explicit indication is provided in at least one of a control signaling message, a data packet header or a control packet data unit.

56. The apparatus according to claim 46, wherein the service network comprises a 5G network.

57. The apparatus according to claim 49, wherein the network functions or services support capability indication comprises at least one of an indication of whether higher layer protocol stack is supported or not, whether in-service flow differentiation scheduler supported or not, open information on predefined general purpose computing platform or application interface which is not vendor sensitive information.

58. An apparatus, comprising:
at least one processor; and
at least one memory comprising computer program code,
the at least one memory and the computer program code are configured, with the at least one processor, to cause the apparatus at least to
transmit a network functions or services support capability indication to a network entity;
receive or obtain cell level network functions or services configuration or reconfiguration information; and
perform on-the-fly cell level network functions or services configuration or reconfiguration.

59. The apparatus according to claim 58, wherein the network functions or services support capability indication comprises at least one of an indication of whether higher layer protocol stack is supported or not, whether in-service flow differentiation scheduler supported or not, open information on predefined general purpose computing platform or application interface which is not vendor sensitive information.

60. The apparatus according to claim 58, wherein the transmitting comprises transmitting the network functions or services support capability indication during deployment, switch-on, activation, or re-activation of the network access element.

61. The apparatus according to claim 58, wherein the configuration or reconfiguration information comprises configuration location of each radio protocol layer for at least one of the network access elements or user equipment or service flow or service sub-flows basis.

62. The apparatus according to claim 58, wherein the on-the-fly cell level network functions or services configuration or reconfiguration is based on at least one of: the cell load, available front or back-haul capacity, or the user services served by the cell.

63. The apparatus according to claim 58, wherein the on-the-fly cell level network functions or services configuration or reconfiguration is performed based on pre-configured policies and/or rules.

64. The apparatus according to claim 58, wherein the at least one memory and the computer program code are further configured, with the at least one processor, to cause the apparatus at least to indicate to the network entity the network functions or services configuration each time the configuration changes.

65. A method, comprising:
transmitting , by a network access element, a network functions or services support capability indication to a network entity;
receiving network functions or services configuration or reconfiguration information; and
performing on-the-fly cell level network functions or services configuration or reconfiguration.
